(19) United States
(12) Patent Application Publication
(10) Pub. No.: US 2007/0014069 A1
(43) Pub. Date: Jan. 18, 2007

(54) Method and apparatus to protect an ethernet network by suppression of transient voltage pulses using a plasma limiter

(75) Inventors: Peter George Krueger, Ooltewah, TN (US); Louie Cecil Elliott, Chattanooga, TN (US); Clifton James Murphy, Chattanooga, TN (US); Thomas Paine Wood, Carrollton, TX (US); Robert Michael Pap, Chattanooga, TN (US)

Correspondence Address: Janet Donovan;Accurate Automation Corporation, 7001 Shallowford Road, Chattanooga, TN, 37421, US

(73) Assignee: Accurate Automation Corporation, Chattanooga, TN (US)

(21) Appl. No.: 11/474,241

(22) Filed: Jun. 23, 2006

Related U.S. Application Data
(60) Provisional application No. 60/693,512, filed on Jun. 24, 2005.

(51) Int. Cl. H02H 9/06

(52) U.S. Cl. 361/120

(57) ABSTRACT

The invention described here is a circuit protection device based on the principle of a plasma limiter. A plasma limiter uses an electrode such as a very sharp tungsten needle in an easily ionized gas to perform field enhancement using the interference voltage to initiate avalanche breakdown of the plasma. The gas becomes conductive, causing the interference voltage to short-circuit to ground thereby protecting the transceiver Integrated Circuit (IC). This device protects IC's that can be damaged by voltages greater than about 15 volts when damaging voltages have occurred on the wire(s) for a brief time. The damaging voltage creates an electromagnetic field that is enhanced by the sharp electrode thereby causing the easily ionized gas to become plasma and conduct between the wire and grounded electrode. This conduction prevents the damaging voltage on the wire from becoming so great that IC's become damaged. A protection module consists of devices to protect one or many signals in a single module. An implementation of the protection module is a free-standing module that is placed inline with a cable. Also, an implementation of the protection module is a device to be mounted on the printed circuit board or mounted to a panel of the circuit to be protected.

### BACKGROUND OF THE INVENTION

Ethernet is a very common form of communications between computers over distances of a few meters to a few thousand meters. Ethernet has both wired and wireless implementations; however, this invention applies to protection of wired Ethernet. The most common form of Ethernet wiring is unshielded twisted pairs of wires known as “CAT-5”. This implementation uses two pairs of serial data bits (4 wires) to communicate transmitted serial data and received serial data between computers. Below is a list of the signals contained in each of the 4 wires of a twisted pair:

TXD+=serial transmit data bit (in-phase)

TXD−=serial transmit data bit (out-of-phase)

RXD+=serial receive data bit (in-phase)

RXD−=serial receive data bit (out-of-phase)

An ‘in-phase’ and ‘out-of-phase’ pair is a balanced pair where the information bit is represented by the polarity of the difference between the two signals rather than the absolute magnitude of the voltage of the two signals. This provides immunity to both voltage losses over long wires and also to voltage interference induced into the signal pair. Since the signal pair is twisted, the two wires are in very close proximity to each other over the full length of the cable. If the twisted pair is exposed to a field that induces an interference voltage, the close proximity causes the two wires to receive virtually the same induced voltage. In such a situation of induced interference voltage, the polarity of the difference between the voltage levels of the balanced pair remains virtually the same as without induced voltage interference. The balanced twisted pair configuration provides high speed and long distance wired communications that has very good immunity to induced voltage interference. However, balanced twisted pair circuits often can be damaged if the signal pair experiences an induced voltage that creates a voltage difference between a signal and the ground of the transceiver Integrated Circuit (IC) in excess of about 15 volts.

Methods to provide immunity from voltage interference pulses have taken primarily two forms: 1) diodes, and 2) gas discharge tubes. Diodes can be placed in the circuit between the wire and the ground of the transceiver so that the diode is reverse biased and has no effect on the transceiver IC unless the voltage level exceeds a threshold at which the diode conducts the voltage to ground protecting the transceiver IC. Such diodes are avalanche diodes or ‘Transorb’. These devices respond quickly and provide good protection from fast, low-power induced voltages. However, if the induced voltage is significantly high, the diode protection devices fail to protect and the transceiver IC is damaged. Gas discharge protection devices place a device such as a neon lamp between the wire and the ground of the transceiver IC. When the voltage on the wire becomes significantly high, the neon lamp illuminates and conducts the high voltage to ground. Gas discharge protection devices can protect against very high induced voltages, but have slow response. If an induced voltage pulse has very fast rise time, gas discharge devices fail to respond quickly enough to protect the transceiver IC thereby causing failure.

To summarize, diode protection devices respond quickly, but fail to protect against high interference voltages present in the wire(s). Conversely, gas discharge protection devices provide protection against high interference voltages in the wires, but fail to respond quickly.

The invention described here is a protection device based on the principle of a plasma limiter. A plasma limiter uses a very sharp field enhancing electrode (such as a tungsten needle) in an easily ionized gas to perform field enhancement using the interference voltage to initiate avalanche breakdown of the gas. The gas becomes conductive, causing the interference voltage to short-circuit to ground thereby protecting the transceiver IC.

### SUMMARY OF THE INVENTION

A method and apparatus to protect wired Ethernet circuits from damage caused by high voltage interference using a plasma limiter is described. Ethernet circuits use transmitter and receiver and transceiver Integrated Circuits (IC's) that can be permanently damaged if the voltage entering those circuits is more than about 15 volts above the ground voltage of the IC. Protection devices previously used provide protection against fast but low-voltage interference or provide protection against high-voltage but slow rise time interference. This invention provides protection against high-speed and high-voltage interference.

This invention is a network wiring protection device that is placed in series with existing network wiring that has no effect on the signal(s) under normal low voltage (less than 15 volts) conditions, but quickly connects the signal to ground if the voltage exceeds a threshold, and continues to hold the connection to ground as long as the high voltage condition exists. This circuit uses a plasma limiter with a field enhancing electrode in an easily ionized gas to initiate avalanche breakdown of the gas. This device can be a small module with an input and an output Ethernet connection as well as a connection for earth ground. The input and output Ethernet connections are RJ-45 connections for CAT-5 Ethernet wiring. The plasma limiter includes a small capsule containing the easily ionized gas, field enhancing eltrodes, and Ethernet pass-through wires in one or more sealed capsules. Where small size is a benefit, the protection device may be constructed in as little as 1 cubic inch. The construction technique has electrical interconnections through a sealed glass vessel filled with low pressure gas, similar to an incandescent or fluorescent lamp. Alternatively, the protection device may be constructed as a module that is mounted on the circuit board where the transceiver IC's to be protected are located. Further, the protection device may be constructed as a panel-mount device that is mounted on the shell or panel of the enclosure housing the printed circuit board(s) to be protected.

The protection technique of this invention is applicable to other forms of Ethernet wiring such as RG-58 ‘thin-net’ coaxial wiring. It is also applicable to other low voltage interconnection techniques where induced high voltage and fast rise time interference is likely to cause damage to the interfacing IC's. This invention is most efficient for serial data interfaces where only one or two pairs of wires must be connected. It can be applied to an interface with many wires, but the size of the protection device becomes large.

### BRIEF DESCRIPTION OF THE DRAWINGS

FIG. 1 is an Electrical Schematic of the Ethernet Protection Device with one pass-through wire.

FIG. 2 is an Electrical Schematic of the Ethernet Protection Device with four pass-through wires.

FIG. 3 depicts three configurations of the Ethernet Protection Device.

FIG. 4 shows Streamer Discharge Development across a Plane Parallel Gap.

### DESCRIPTION OF THE PREFERRED EMBODIMENT

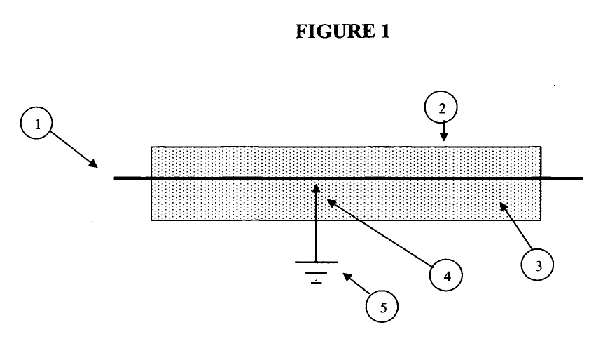

This invention is a method and apparatus to protect wired Ethernet circuits from damage caused by high voltage interference using a plasma limiter. This is a module with input and output Ethernet connections and a connection for chassis ground containing a capsule with field enhancing electrode and an easily ionized gas. FIG. 1 shows the electrical schematic of a one-wire protection device. An Ethernet wire, 1), passes through the protection device. Outside the protection device the Ethernet wire is insulated and each balanced pair comprising a signal is twisted to provide very close proximity of the wires. Inside the sealed capsule, 2), Ethernet wire has an uninsulated region exposing the conductors of the Ethernet wire to an easily ionized gas, 3), in the very close proximity of a field enhancing electrode, 4). A conductor from the field enhancing electrode, 4), passes through the sealed capsule, 2), to an earth ground connection, 5). If the voltage on the wire becomes high, then a strong field forms at the electrode, 4), and the easily ionized gas begins to breakdown. Upon breakdown, the easily ionized gas becomes conductive holding the Ethernet wire, 1), at a voltage very near chassis ground. A CAT-5 Ethernet unshielded twisted pair contains four Ethernet wires and would be constructed using 4 modules such as shown in FIG. 1. A high voltage on any of the four wires causes a strong field on the corresponding field enhancing electrode, 4), causing breakdown of the easily ionized gas, 3), thereby holding that high voltage wire at ground potential.

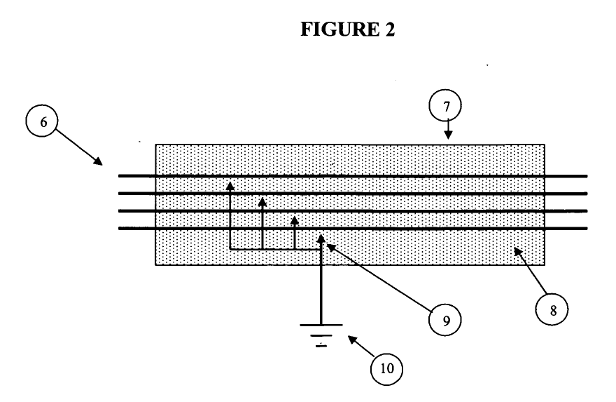

FIG. 2 shows the electrical schematic of an alternate implementation of a four-wire protection device, such as a CAT-5 Ethernet cable. An Ethernet cable with four conductors, 6), passes through the protection device. Outside the protection device the Ethernet wires are insulated and each balanced pair comprising a signal is twisted to provide very close proximity of the wires. Inside the sealed capsule, 7), the Ethernet wires have an uninsulated region exposing the conductors of the Ethernet wires to an easily ionized gas, 8), in the very close proximity of field enhancing electrodes, 9). A conductor from the electrodes, 9), passes through the sealed capsule, 7), to an earth ground connection, 10). If the voltage on any wire becomes high, then a strong field forms at the corresponding field enhancing electrode, 9), and the easily ionized gas begins to breakdown. Upon breakdown, the easily ionized gas becomes conductive holding the Ethernet wire which has a high voltage at a voltage very near chassis ground. A CAT-5 Ethernet unshielded twisted pair contains four Ethernet wires and such a protection device for a CAT-5 cable using the implementation of FIG. 2 would have four field enhancing electrodes. A high voltage on any of the four wires causes a strong field on the corresponding electrode, 9), causing breakdown of the easily ionized gas, 8), in that region thereby holding that wire at ground potential.

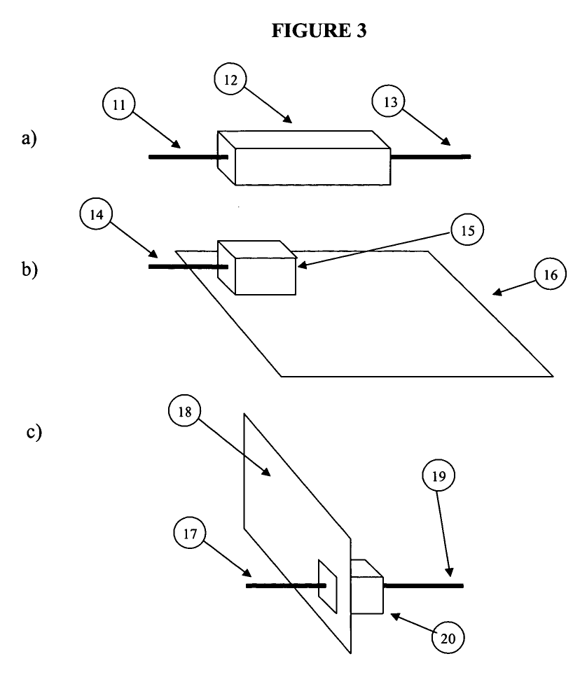

FIG. 3 shows three configurations of the Ethernet protection device. FIG. 3 a) shows a freestanding inline protection device. The incoming Ethernet cable, 11) and 13), enters the protection device containing the easily ionized gas and field enhancing electrode, 12), at opposite ends of the device. The two entry points are interchangeable. In a device protecting CAT-5 wiring, each connection point, 11) and 13), is an RJ-45 connector. The protection device, 12), is connected to earth ground through the mounting of the device or through a connection wire attached to the protection device. FIG. 3 b) shows a protection device configured as a device mounted to a printed circuit board. The incoming Ethernet cable, 14), enters the protection device, 15), which is mounted on a printed circuit board, 16), which contains IC's to be protected. The protection device is attached to the ground potential of the IC's. FIG. 3 c) shows a protection device configured as a panel-mounted component. The incoming Ethernet cable, 17), enters the protection device, 20), which is mounted to the enclosure housing the IC's to be protected, 18). The protected Ethernet cable, 19), exits the protection device and is connected to the printed circuit board containing the IC's to be protected. The protection device is connected to ground potential at the enclosure to which it is mounted or through a cable.

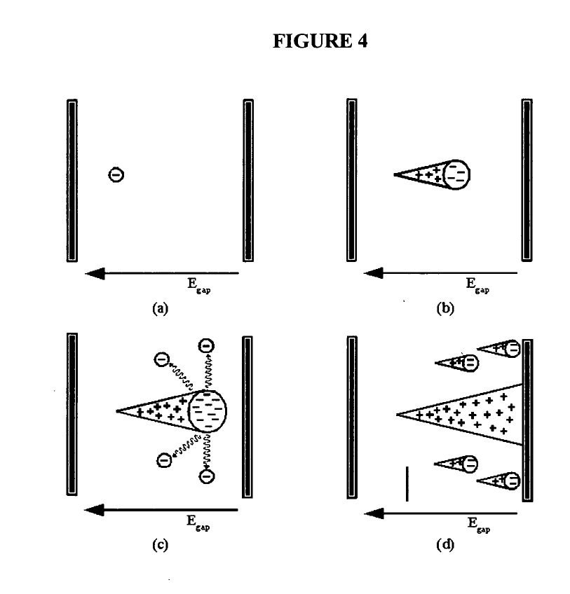

FIG. 4 shows streamer discharge development across a plane parallel gap such as across the gap between the Ethernet wire and the field enhancing electrode. In FIG. 4 a), an initial free electron is attracted across the parallel gap. In FIG. 4 b), initial electron avalanche has begun to form between the Ethernet wire and the field enhancing electrode. In FIG. 4 c), intense electric field due to space charge starts photoionization in the parallel gap. In FIG. 4 d), initial electron avalanche multiplies into multiple electron avalanches causing a low impedance path between the electrodes of the gap.

A high electric field forms at needle points from the applied electric field and the sharp geometry. When the electric field at the needle is extremely high, on the order of MV/cm, it pulls electrons away that escape the metal cathode by tunneling. There is no statistical delay with this process and no active devices.

Once the electrons are introduced into the gap, a streamer discharge begins via the Townsend breakdown mechanism. Breakdown initially starts with a free electron located somewhere between a pair of electrodes. An electric field between electrodes exerts a force on the free electron and accelerates it until it collides with a neutral atom or molecule. If the electron has gained enough kinetic energy, the collision is inelastic and the neutral atom is ionized. The collision results in two free electrons and one positive ion. The process repeats and the two electrons become four, and so on. This process is known as an electron avalanche. If enough avalanches occur over a period of time, complete electrical breakdown (Townsend breakdown) is said to have occurred.

Streamer discharge starts out much like a Townsend breakdown with an initial electron avalanche. The Townsend mechanism however falls short in explaining breakdown in overvoltaged gaps (gaps in which the applied voltage is >20% of the dc breakdown voltage). There are two processes occurring in overvoltaged gaps that the Townsend mechanism does not consider. The first is photoemission and photoionization. As the electron avalanches are forming and growing, some of the metastable states return to ground state and emit energetic photons. The photons when absorbed by neutrals result in further ionization.

The second process is the self-generated electric field of the space charge in the avalanche. As the avalanche increases in numbers of electrons, so does its self-generated electric field. When the self-generated electric field becomes close to the external electric field due to the gap voltage, significant changes in electron energies and ionization occur locally. A schematic of the temporal development of a streamer discharge is shown in FIG. 4.

Streamer development is a very fast process. Velocities can be as high as 4×10⁶ m/sec or 1.3% the speed of light. Streamers can cross a 1 cm gap in less than 1 nanosecond, depending on the magnitude of the applied voltage, gas pressure, and the non-uniformity of the E-field

Once the streamer crosses the cell gap, a complex thermal process increases the channel conductivity. At this time, the discharge is fully developed and the gap is considered to be conducting. It has been shown experimentally that these three processes, electron field emission, streamer discharge, and increased channel conductivity, can occur in less than a nanosecond when the electric fields across the gap and near the needle are high enough.

When the applied voltage is removed, the gas within the cell gap requires a finite period of time to return to its natural state (before ionization). This is the relaxation or deionization time of the particular ionized gas. Deionization is a complex process composed of many phenomena. Within the gas itself, deionization will occur predominately via diffusion, recombination, and attachment. For a plasma limiter, the relaxation time determines the recovery time of the overall system.

We claim:

1) A device that protects a low voltage signal wire and its associated circuits from damage due to high voltage pulse interference where the device is comprised of:
a) a capsule of easily ionized gas surrounding the wire carrying the signal to be protected,
b) a field enhancing electrode such as a very sharp tungsten needle in very close proximity to the uninsulated conductor of the wire to be protected,
c) a conductive path from the field enhancing electrode exiting the capsule to be connected to earth ground potential, and,
d) a means to connect the wire external to the capsule to the wire running through the capsule so that a low impedance path is formed between the input and output wire.

2) The device of claim 1 where multiple capsules, each containing an easily ionized gas and one signal wire and one field enhancing electrode are used to protect multiple signals carried on multiple wires.

3) A device that protects multiple low voltage signal wires and their associated circuits from damage due to high voltage pulse interference where the device is comprised of:
a) a capsule of easily ionized gas surrounding the wires carrying the signal to be protected,
b) a field enhancing electrode such as a very sharp tungsten needle in very close proximity to the uninsulated conductor of each wire to be protected,
c) a conductive path from the field enhancing electrode exiting the capsule to be connected to earth ground potential, and,
d) a means to connect the wires external to the capsule to the wires running through the capsule so that a low impedance path is formed between the input and output wires.

4) The device of claim 1 where the wires to be protected are the 4 wires of a CAT-5 Ethernet circuit.

5) The device of claim 1 where the wires to be protected are the wires (signal and ground) of an Ethernet ‘thin-net’ RG-58 circuit.

6) The device of claim 3 where the wires to be protected are the 4 wires of a CAT-5 Ethernet circuit.

7) The device of claim 3 where the wires to be protected are the wires (signal and ground) of an Ethernet ‘thin-net’ RG-58 circuit.

8) The device of claim 1 where the signals to be protected are the low voltage signals of any interface between devices where the interface contains one or many signals and the interface circuits are susceptible to damage from high voltage interference.

9) The device of claim 3 where the signals to be protected are the low voltage signals of any interface between devices where the interface contains one or many signals and the interface circuits are susceptible to damage from high voltage interference.

10) The device of claim 1 configured as a protection module that is wired inline with the circuit to be protected as a free-standing module.

11) The device of claim 1 configured as a protection module that is mounted to the printed circuit board containing the circuit to be protected.

12) The device of claim 1 configured as a protection module that is mounted to the enclosure of the circuit to be protected.

13) The device of claim 3 configured as a protection module that is wired inline with the circuit to be protected as a free-standing module.

14) The device of claim 3 configured as a protection module that is mounted to the printed circuit board containing the circuit to be protected.

15) The device of claim 3 configured as a protection module that is mounted to the enclosure of the circuit to be protected.
